(19) United States
(12) Patent Application Publication
(10) Pub. No.: US 2016/0296045 A1
(43) Pub. Date: Oct. 13, 2016

(54) Gecko frame

(71) Applicant: Ted Greg Lee Frumkin, Herzeliya (IL)

(72) Inventor: Ted Greg Lee Frumkin, Herzeliya (IL)

(21) Appl. No.: 15/096,336

(22) Filed: Apr. 12, 2016

Related U.S. Application Data
(60) Provisional application No. 62/146,314, filed on Apr. 12, 2015.

(51) Int. Cl. A47G 1/17; C09J 7/02; F16M 13/02; A47G 1/06; A47B 97/00

(52) U.S. Cl. CPC A47G 1/17; A47G 1/06; A47B 97/001; F16M 13/022; C09J 7/02

(57) ABSTRACT

The present invention is directed to frames of framed products that are hanged, connected with reusable stickiness (adhesive) to hang and rehang on different surfaces. The present invention also includes gecko adhesive on the front of the frame for hanging the products in the gecko frame. While the gecko's “glue” holds the frame strongly in one direction, one can easily pull the gecko frame to the other direction and remove to hang the frame again. Due to the gecko frame no nails needed hence not damaging the wall and no residue leftovers, as well the shape of the frame can be changed and not necessarily symmetric. The present invention also include a frame that has reusable adhesive made out of carbon nanotubes mimicking a gecko foot. realizing a frame hanged on different surfaces without leaving any residue or be hanged by a nail, rather by a special “glue” or any other glue product which doesn't leave residue, reusable, easy to use and doesn't wear off even in dusty or damp conditions.

### PRIORITY DATA

The present applications claims priority from U.S. provisional patent 62/146,314 filed on Apr. 12, 2015 by the inventor of the present application and is hereby incorporated by reference in its entirety.

### FIELD OF THE INVENTION

The present invention generally relates to frames of hanged products such as pictures, drawings, TV's, clocks etc. (will be referred as frame) for hanging, and in particular, it concerns reusable adhesive on the frame for hanging it.

### BACKGROUND OF THE INVENTION

In a world where new techniques are implemented in all areas of our lives, people tend to get the easier technology, and companies are trying to produce solutions for them, to make life easier. Up to now when someone wanted to hang a picture on the wall, he had to use nails or a tape etc. in which all this techniques rather destroy the wall (holes made by nails) or leaving signs (leftovers from the tape), besides the damages left on the wall these techniques are not reusable. With this innovative idea, we propose a complete new way of hanging framed pictures, clocks, TVs etc., by using a material that has reusable stickiness that can hold the frame on the wall, easy to hang and remove when needed.

Note, all materials that have stickiness (by glue, vacuum or other forces) that can hang the frame, and the stickiness doesn't wear off with water or even in dusty or damp conditions, and can easily free the frame from the surface, can be used and will be referred as gecko “glue”.

Non-limiting exemplary embodiments of exemplary includes an adhesive imitating the geckos foot. The adhesive is made out of carbon nanotubes, it can hold on extremely strong in one direction, and can be easily freed on the other direction.

Geckos have the remarkable ability to cling to just about any surface, even something as smooth and slippery as glass. It's not due to suction, glue or Velcro-like bristles. Instead, geckos toe pads are covered with millions of tiny, flexible hairs. When a gecko plants its foot, the individual hairs come in extremely close contact with the surface is climbing on. That super-closeness makes it possible for atoms and molecules in the hairs to attract their counterpart atoms and molecules in the surface layer.

This attraction is called the Van Der Waals force (after the discoverer). The attraction is weak, but its effect is multiplied by the density and sheer number of hairs (or in the glue case the carbon nanotubes) on the gecko's toe pads. Each hair stalk, or seta, branches into hundreds of smaller, flattened tips called spatulae. The setae are able to shed dirt and to an extent, water, meaning a gecko's stickiness doesn't wear off even in dusty or damp conditions. To unstick its feet a gecko curls its toes upward (the other direction), peeling the setae away from the surface.

Referring to FIG. 1, inspired from the structure found on gecko feet, an optional embodiment synthesized carbon nanotube-based hierarchical hairy structure. Carbon nanotubes can be synthesized using chemical vapor deposition. Image of scanning electron microscope (SEM) of pillars of carbon nanotubes,

Referring to FIG. 2, non-limiting example patterns of pillared size ranging from 50-500 μm. The patterns act as setae and individual carbon nanotubes as spatula. These vertically aligned nanotubes can be transferred onto a polymeric substrate (the geometry would be referred as gecko tape). By optimizing the pattern size and the size and height of carbon nanotubes, very high shear forces can be achieved. For a non-limiting example 50 μm pattern size with 200 μm carbon nanotube length showed four times higher adhesion than natural gecko foot.

### SUMMARY

The present invention is directed to framed products such as pictures clocks TVs etc., connected with reusable stickiness to be hanged on the surface.

In addition to the adapted frames noted above, the present invention also includes the use of a carbon nanotube “glue” imitating the gecko's foot, for hanging the pictures, clocks and other products. The “glue” imitating the gecko's foot can be hanged easily on the surface in one direction while it can be taken off easily by pulling them to the other direction. As well the gecko's “glue” can be reused and it doesn't wear off even in dusty or damp conditions.

An additional advantage of the new inventive gecko frame is that the framed products can be hanged also on glass (i.e. windows), metal and plastic surfaces. The framed product can have different shapes and can be hanged sideways or upside down, depending on the design. This concept is applicable to all types of framed hanged products,

In addition the gecko frame can have gecko “glue” at the front for hanging the picture in the frame or other products such as cellphone, wallet, keys etc., the gecko frame can be adjusted by size and shape for different locations (applications) such as in cars, hoses etc.

As mentioned, our objective is to realize a framed picture that can be hanged on the wall without the need of nails or tapes (for not damaging the wall), rather by a special frame consisting of the gecko imitating adhesive.

In an exemplary, non-limiting embodiment the adhesive consists of carbon nanotubes imitating the gecko's foot, can stick on the back of the frame holding the picture, clock, TV etc, on the wall, without damaging the wall and easy to hang and take off, and rehang in a different location. To hang, take off and rehang, the gecko frame just need a pool to the opposite direction, the gecko frame can be reusable.

The gecko frame will be made by a thin layer (the thickness will be determined by the size and weight of the framed product, for example on a big painting frame the thickness will grow compared to a small picture frame) based on the back of the frame. The gecko “glue” can be dispersed on all the back part of the frame, or the gecko's “glue” can be dispersed only on certain locations at the back of the frame, for creating a good enough stickiness, thus saving gecko “glue” material.

Additional advantage of the Gecko frame, can hold Gecko mimicking adhesive on the front (or face) of the frame thus one can hang a product like a picture/TV/keys/wallet/cellphone Etc. on the frame.

An additional advantage, the shape and size of the frame can be adjusted for different purposes (does not have to be symmetric) as needed e.g. location of the frame inside a car on the dashboard or inside a house on different surfaces and for different products that are hanged on the frame.

### BRIEF DESCRIPTION OF FIGURES

FIG. 1: pillars of carbon nanotubes mimicking the setae.

FIG. 2.: individual carbon nanotubes as the spatula.

FIG. 3: example of a damaged wall from a nail.

FIG. 4: example of a hanged picture with a nail on the wall.

FIG. 5: non-limiting example of the gecko frame front.

FIG. 6: non-limiting example of the back of a gecko frame.

FIG. 7: non-limiting example of the back of a gecko frame with adhesive dispersed on certain locations.

FIG. 8: non-limiting example of Gecko frame with gecko “glue” on the front.

FIG. 9: non-limiting example of different shape gecko frame.

### DETAILED DESCRIPTION

The principles and operation of the apparatus and method according to a present embodiment may be better understood with reference to the drawings and the accompanying description. A present invention is an apparatus for an adhesive frame. The apparatus facilitates hanging the frame, using an innovative gecko “glue”. The gecko frame hangs on the surface with reusable adhesive material that does not leave residue, in order to stick and unstick. The frame shapes with the gecko adhesive can change due to the unnecessary need of being symmetric to be hanged by a nail on the surface, hence different shapes of frames can be made not only rectangular and circular but any imaginable shape.

Current research in the field is focused on improving the conventional use of material the frame is made from and the wire that hangs on the nail. A gecko frame can be for multiuse meaning a frame that can be hanged and rehanged on the surface without damaging or leaving any residue. As well, the gecko frame can be hanged on different surfaces such as on the wall on glass or metal etc.

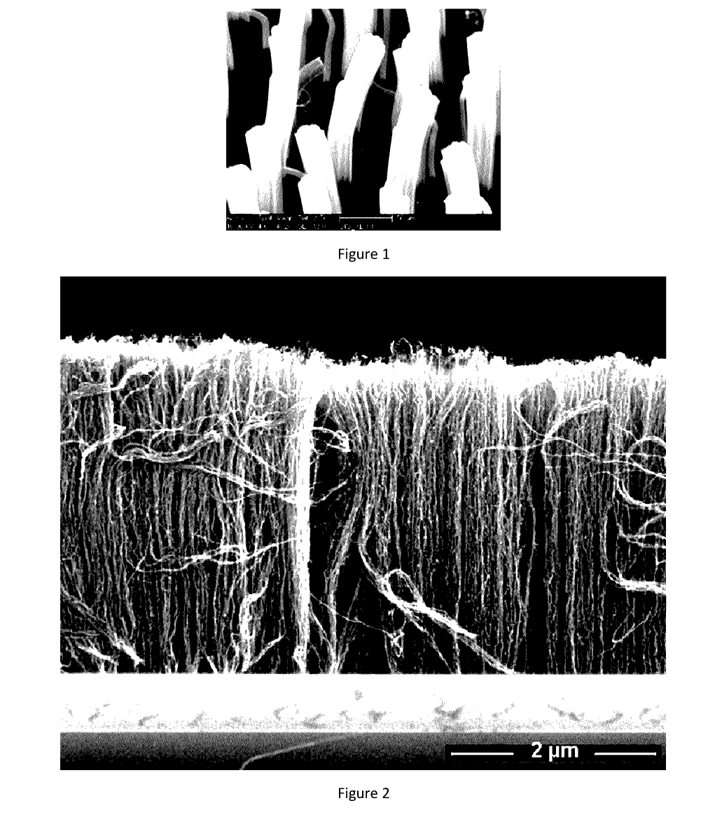

Refer to FIG. 1, non-limiting example of a top view SEM picture of pillars contain out of carbon nanotubes. The pillars act as the setae in order to create adhesive mimicking the gecko's foot. The pillars size and shape can be adjusted to a specific product in order to get the best adhesive.

Refer to FIG. 2, non-limiting example of a side view zoom of a pillar a cluster of carbon nanotubes, individual carbon nanotube can be seen. The individual carbon nanotubes act as the spatula in order to create adhesive mimicking the gecko's foot. The carbon nanotube size and height can be adjusted to a specific product demands.

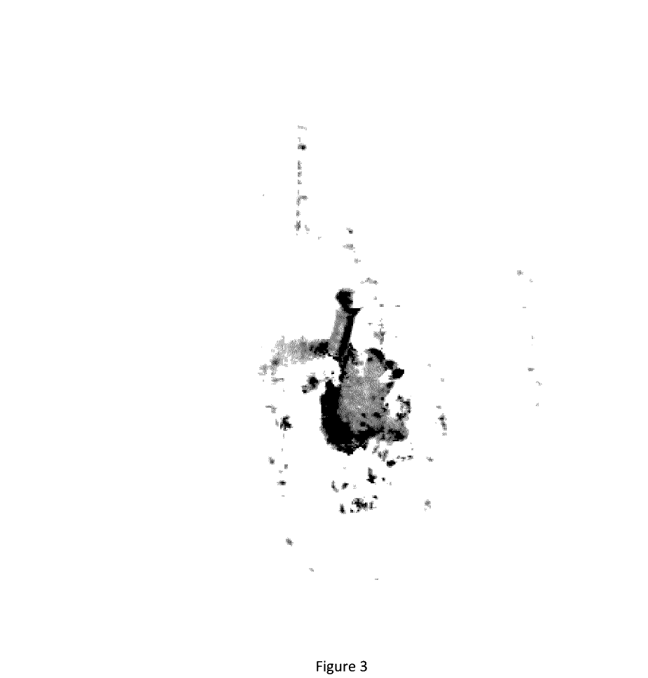

Refer to FIG. 3, non-limiting example of a wall damaged by a nail. It is difficult to knock the nail on the wall, the wall is damaged from the nail and when a nail is taken out the damage become bigger. Hanging a frame with a nail is not reusable and a nail can only be knocked on specific surfaces.

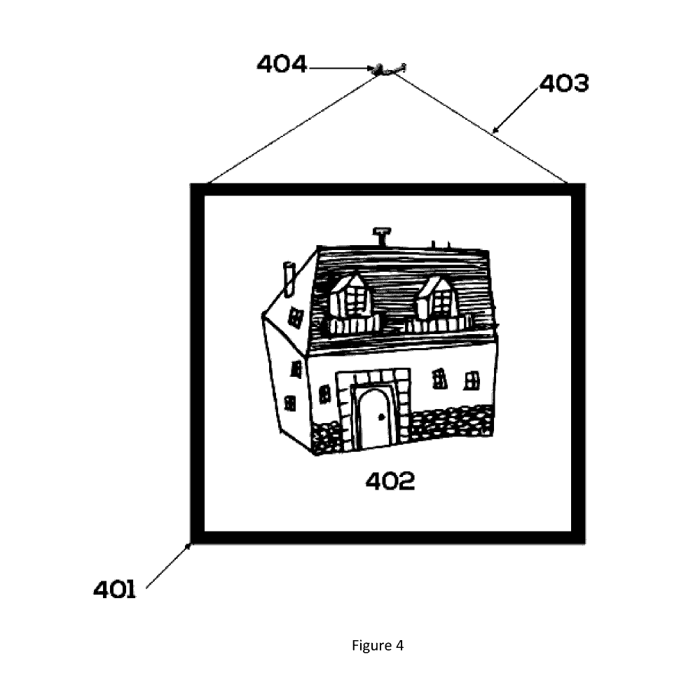

Refer to FIG. 4, non-limiting example of a frame 401 with a picture 402 (note that the picture can be other products such as TV or a clock etc.). The frame is hanged by a string 403 on a nail 404 from above it. Note that the nail can be on the backside of the frame and not above) as well the frame can be hanged directly on the nail.

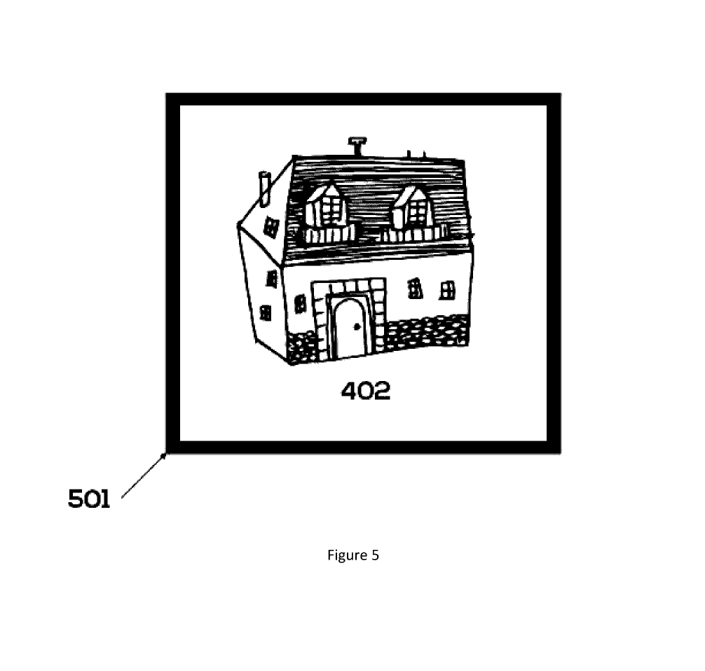

Refer to FIG. 5, non-limiting example of the front side of the gecko frame 501 with a picture 402. The gecko frame is not connected to any strings neither has holes in the back to hang it directly on the nail, rather it is hanged on the wall by an adhesive mimicking the geckos foot.

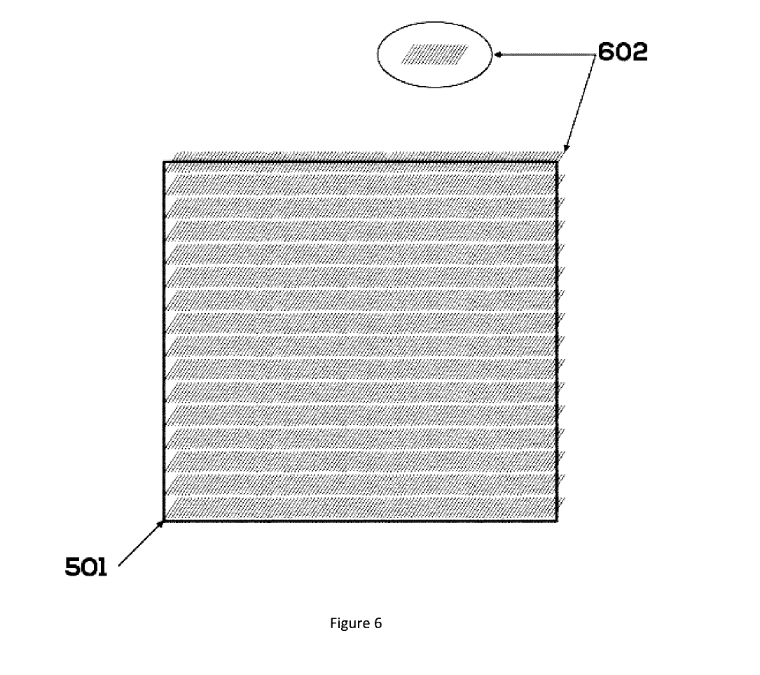

Refer to FIG. 6, non-limiting example of the gecko frame 501 backside. In this case, all the backside of the frame is covered with the gecko imitating adhesive 602. Note: all materials such as wood, plastic, silicon or metal etc. can be used in order to produce the gecko frame. All materials that can mimic the gecko adhesive can be used.

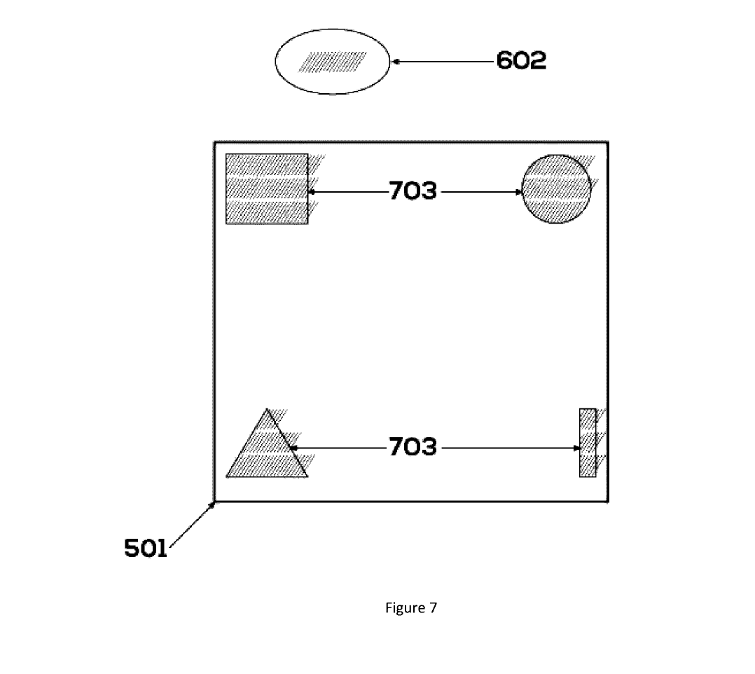

Refer to FIG. 7, non-limiting example of gecko frame 501 backside, where the gecko imitating adhesive 602 is dispersed only on certain locations. The shape, size and location of the adhesive 703 can change in order to adjust to the product.

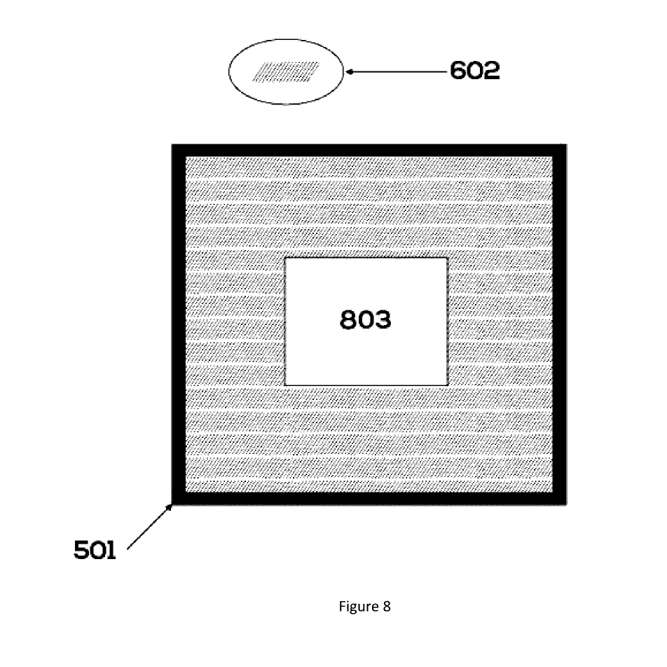

Refer to FIG. 8, non-limiting example of a Gecko frame 501 with gecko adhesive 602 on the front. Different products 803 (such as a picture, Tv, clock, wallet, phone, keys etc, can be hanged on the front of the gecko fame) can be hanged on the gecko adhesive in the front of the gecko frame. The frame shape can be adjusted to put in a car etc.

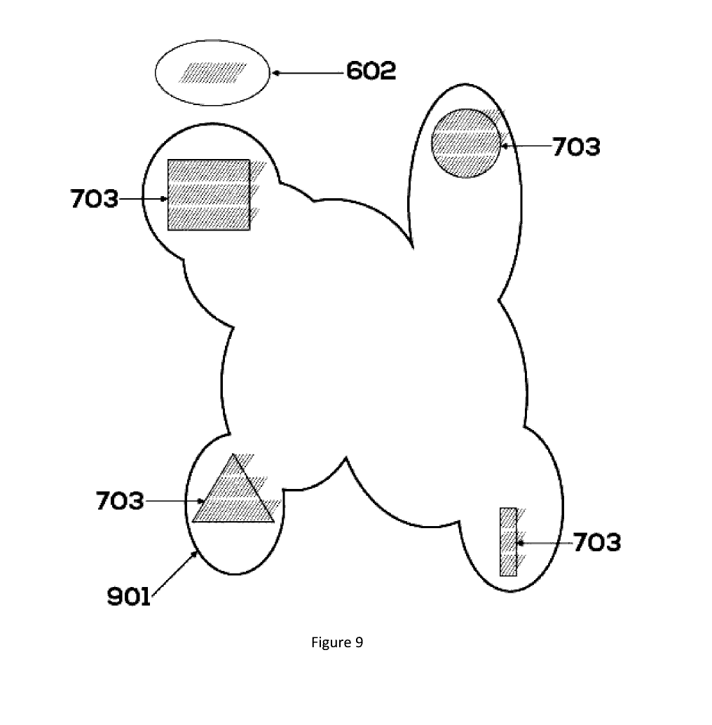

Refer to FIG. 9, non-limiting example of a different shape Gecko frame 901 backside and gecko adhesive 602 in different locations and shapes 703. The different shape of the gecko frame does not need to be symmetrical, as it needs in order to be hanged on a nail. The frame shape can be adjusted to put in a car etc. or it can be adjusted for the specifics of different products.

A gecko frame has been shown to provide improved and easier hanging frames and products in the frame compared to conventional techniques, and is a preferred implementation. Alternatively, the shape of the frame can change due to the lack of symmetrical need for hanging a frame on a nail.

The choices used to assist in the description of this embodiment should not detract from the validity and utility of the invention. It is foreseen that more general choices including, but not limited to materials, different shape size and configuration can be used, depending on the application.

The use of simplified calculations to assist in the description of this embodiment should not detract from the utility and basic advantages of the invention.

It should be noted that the above-described examples, numbers used, and exemplary calculations are to assist in the description of this embodiment. Inadvertent typographical and mathematical errors should not detract from the utility and basic advantages of the invention.

It will be appreciated that the above descriptions are intended only to serve as examples, and that many other embodiments are possible within the scope of the present invention as defined in the appended claims.

What is claimed is:

1. A frame comprising:
a front; and
a back with a back contact surface including microstructure, nanostructure or picostructure based adhesive.

2. The frame according to claim 1, wherein said adhesive is adapted to affix the said frame o different surfaces.

3. A frame comprising:
a front with a contact surface including microstructure, nanostructure or picostructure based adhesive.

4. The frame according to claim 3, wherein said adhesive is adapted to affix products to the front contact surface.
